(19) United States
(12) Patent Application Publication
(10) Pub. No.: US 2026/0005789 A1
(43) Pub. Date: Jan. 1, 2026

(54) WIRELESS COMMUNICATION METHODS, DEVICE, AND STORAGE MEDIUM

(71) Applicant: GUANGDONG OPPO MOBILE TELECOMMUNICATIONS CORP., LTD., Dongguan (CN)

(72) Inventors: Xiaogang CHEN, Shanghai (CN); Wei Wen, Shanghai (CN)

(73) Assignee: GUANGDONG OPPO MOBILE TELECOMMUNICATIONS CORP., LTD., Dongguan (CN)

(21) Appl. No.: 19/319,172

(22) Filed: Sep. 4, 2025

Related U.S. Application Data
(63) Continuation of application No. PCT/CN2023/142904, filed on Dec. 28, 2023.
(60) Provisional application No. 63/450,278, filed on Mar. 6, 2023.
(60) Provisional application No. 63/451,222, filed on Mar. 9, 2023.
(60) Provisional application No. 63/451,221, filed on Mar. 9, 2023.

(51) Int. Cl. H04L 1/00; H04B 7/06

(52) U.S. Cl. CPC H04L 1/0003; H04B 7/0663; H04L 1/0025

(57) ABSTRACT

Wireless communication methods, a device and a storage medium are provided. A method includes: a station transmits a first message to an access point, the first message carrying a field indicating a highest modulation and coding scheme (MCS).

### CROSS-REFERENCE TO RELATED APPLICATIONS

This application is a continuation of International Application No. PCT/CN2023/142904, filed on Dec. 28, 2023, which is filed based on and claims priority to U.S. patent application No. 63/450,278, filed on Mar. 6, 2023, U.S. patent application No. 63/451,222, filed on Mar. 9, 2023 and U.S. patent application No. 63/451,221, filed on Mar. 9, 2023. The contents of the above patent applications are hereby incorporated by reference in their entirety.

### TECHNICAL FIELD

The present disclosure relates to the field of mobile communication technologies, and more particularly to a method and device for wireless communication, and a storage medium.

### BACKGROUND

Wireless Local Area Network (WLAN) industry is one of the fastest-growing industries in the entire field of data communication at present. As a supplement and expansion to a traditional wired local area network, a WLAN solution has gained popularity among home network users, small and medium-sized office users, a wide range of enterprise users and telecom operators due to its advantages such as flexibility, mobility, scalability and relatively low investment costs, and has been applied rapidly.

### SUMMARY

Embodiments of the present disclosure provides a method and device for wireless communication, and a storage medium.

An embodiment of the present disclosure provides a method for wireless communication, which includes the following operations.

A station (STA) receives a non-trigger based (non-TB) sounding frame from an access point (AP).

The STA adjusts a compressed beamforming feedback (CBF) based on a first matrix. The CBF is configured to respond to the non-TB sounding frame, and the first matrix is used for controlling a ratio between signal-to-noise ratios (SNRs) of two spatial streams of the CBF.

The STA transmits the adjusted CBF to the AP.

An embodiment of the present disclosure provides a method for wireless communication, which includes the following operations.

An AP transmits a non-TB sounding frame to a STA.

The AP receives a CBF adjusted based on a first matrix from the STA. The CBF is configured to respond to the non-TB sounding frame, and the first matrix is used for controlling a ratio between SNRs of two spatial streams of the CBF.

An embodiment of the present disclosure provides a STA. The STA includes a first communication unit and a first processing unit.

The first communication unit is configured to receive a non-TB sounding frame from an AP.

The first processing unit is configured to adjust a CBF based on a first matrix. The CBF is configured to respond to the non-TB sounding frame, and the first matrix is used for controlling a ratio between SNRs of two spatial streams of the CBF.

The first communication unit is further configured to transmit the adjusted CBF to the AP.

An embodiment of the present disclosure provides an AP. The AP includes a second communication unit.

The second communication unit is configured to transmit a non-TB sounding frame to a STA.

The second communication unit is further configured to receive a CBF adjusted based on a first matrix from the STA. The CBF is configured to respond to the non-TB sounding frame, and the first matrix is used for controlling a ratio between SNRs of two spatial streams of the CBF.

A communication device provided by an embodiment of the present disclosure may be the STA or AP in the above methods, and the communication device includes a processor and a memory. The memory is configured to store a computer program, and the processor is configured to call the computer program from the memory and run the computer program to perform the above methods for wireless communication.

An embodiment of the present disclosure provides a chip, which is configured to perform the above methods for wireless communication.

Specifically, the chip includes a processor configured to call a computer program from a memory and run the computer program, to cause a device equipped with the chip to perform the above methods for wireless communication.

An embodiment of the present disclosure provides a computer-readable storage medium, which is configured to store a computer program. The computer program causes a computer to perform the above methods for wireless communication.

An embodiment of the present disclosure provides a computer program product including computer program instructions. The computer program instructions cause a computer to perform the above methods for wireless communication.

An embodiment of the present disclosure provides a computer program that, when running on a computer, causes a computer to perform the above methods for wireless communication.

In the above technical solutions, the STA controls adjustment of the CBF through the first matrix and transmits the adjusted CBF to the AP, thereby controlling the ratio between the SNRs of the two spatial streams of the CBF through the first matrix and thus improving performance.

### BRIEF DESCRIPTION OF THE DRAWINGS

The accompanying drawings described herein are intended to provide a further understanding of the present disclosure and constitute a part of the present disclosure. The schematic embodiments of the present disclosure and the description thereof are intended to explain the present disclosure, and do not constitute an undue limitation of the present disclosure. In the drawings:

FIG. 1 is a schematic diagram illustrating an application scenario according to an embodiment of the present disclosure.

FIG. 2A is a schematic diagram illustrating an architecture of another communication system according to an embodiment of the present disclosure.

FIG. 2B is a schematic diagram illustrating an architecture of another communication system according to embodiments of the present disclosure.

FIG. 3 is an optional flowchart illustrating a method for wireless communication according to an embodiment of the present disclosure.

FIG. 4 is an optional flowchart illustrating a method for wireless communication according to an embodiment of the present disclosure.

FIG. 5 is an optional flowchart illustrating a method for wireless communication according to an embodiment of the present disclosure.

FIG. 6 is an optional flowchart illustrating a method for wireless communication according to an embodiment of the present disclosure.

FIG. 7 is an optional flowchart illustrating a method for wireless communication according to an embodiment of the present disclosure.

FIG. 8 is an optional flowchart illustrating a method for wireless communication according to an embodiment of the present disclosure.

FIG. 9 is an optional diagram illustrating extremely high throughput (EHT) non-TB sounding according to an embodiment of the present disclosure.

FIG. 10 is an optional diagram illustrating a distribution of a gap between average SNRs from two spatial streams according to an embodiment of the present disclosure.

FIG. 11 is an optional diagram illustrating an EHT multiple-input multiple-output (MIMO) control field according to an embodiment of the present disclosure.

FIG. 12 is an optional diagram illustrating adjacent channel interference (ACI) according to an embodiment of the present disclosure.

FIG. 13 is an optional diagram illustrating a current EHT operating mode (OM) control subfield before and after a change in an HE variant according to an embodiment of the present disclosure.

FIG. 14 is an optional schematic structural diagram of a preamble of a first physical layer protocol data unit (PPDU) according to an embodiment of the present disclosure.

FIG. 15 is an optional schematic structural diagram of a preamble of a first PPDU according to an embodiment of the present disclosure.

FIG. 16 is an optional schematic structural diagram of an STA according to an embodiment of the present disclosure.

FIG. 17 is an optional schematic structural diagram of an AP according to an embodiment of the present disclosure.

FIG. 18 is a schematic structural diagram of a communication device according to an embodiment of the present disclosure.

FIG. 19 is a schematic structural diagram of a chip according to an embodiment of the present disclosure.

FIG. 20 is a schematic block diagram of a communication system according to an embodiment of the present disclosure.

### DETAILED DESCRIPTION

Technical solutions in the embodiments of the present disclosure will be described below in combination with the drawings in the embodiments of the present disclosure. It is apparent that the described embodiments are not all embodiments but only part of embodiments of the present disclosure. All other embodiments obtained by those of ordinary skill in the art based on the embodiments in the present disclosure without creative work shall fall within the scope of protection of the present disclosure.

The technical solutions of the embodiments of the present disclosure may be applied to various communication systems, for example, WLAN, Wireless Fidelity (WiFi), or other communication systems. Supported frequency bands for the WLAN may include, but are not limited to: low frequency bands (2.4 GHz, 5 GHz, 6 GHz) and high frequency bands (45 GHz, 60 GHz).

FIG. 1 is an example of an architecture of a communication system according to an embodiment of the present disclosure.

As illustrated in FIG. 1, a communication system 100 may include an access point (AP) 110 and a station (STA) 120 that accesses the network through the AP 110. In some scenarios, the AP 110 may also be referred to as an AP STA. That is, in a sense, the AP 110 is also a STA. In some scenarios, the STA 120 is referred to as a non-AP STA. In some scenarios, the STAs 120 may include both an AP STA and a non-AP STA. Communications in the communication system 100 may include communication between an AP 110 and a STA 120, or communication between a STA 120 and another STA 120, or communication between a STA 120 and a peer STA, where the peer STA may refer to a peer device communicating with the STA 120, for example, the peer STA may be an AP, or a non-AP STA.

The AP 110 may be used as a bridge connecting a wired network and a wireless network, and has a main function to connect various wireless network clients together and then access the wireless network to Ethernet. The AP 110 may be a terminal device with a WiFi chip (such as a mobile phone) or a network device (such as a router).

It should be noted that a role of the STA 120 in the communication system is not absolute, that is, the role of the STA 120 in the communication system can be switched between the AP and the STA. For example, in some scenarios, when a mobile phone is connected to a router, the mobile phone is the STA, and when the mobile phone is a hotspot for other phones, the phone acts as the AP.

In some embodiments, the AP 110 and the STA 120 may be devices applied in the internet of Vehicles, nodes or sensors in internet of things (IoT), smart cameras, smart remote controls or smart water meters and electricity meters in a smart home, sensors in a smart city, or the like.

In some embodiments, the AP 110 may be a device supporting an 802.11be standard. The AP may also be a device supporting a variety of current and future 802.11 family WLAN standards, including 802.11ax, 802.11ac, 802.11n, 802.11g, 802.11b, and 802.11a. In some embodiments, the STA 120 supports the 802.11be standard. The STA also supports the variety of current and future 802.11 family WLAN standards, including 802.11ax, 802.11ac, 802.11n, 802.11g, 802.11b and 802.11a.

In some embodiments, the AP 110 and/or the STA 120 may be deployed on land and include indoor or outdoor, hand-held, wearable or vehicle-mounted devices, may also be deployed on a water surface (such as ships), and may further be deployed in the air (such as airplanes, balloons, satellites and the like).

In some embodiments, the STA 120 may be a WLAN/WiFi-enabled mobile phone, a pad, a computer with a wireless transceiver function, a virtual reality (VR) device, an augmented reality (AR) device, a wireless device in an industrial control, a set-top box, a wireless device in self-driving, an in-vehicle communication device, a wireless device in a remote medical, a wireless device in a smart grid, a wireless device in a transportation safety, a wireless device in a smart city, a wireless terminal device in a smart home, a vehicle-mounted communication device, a wireless communication chip/application specific integrated circuit (ASIC)/system on chip (SoC), or the like.

Exemplarily, the STA 120 may also be a wearable device. The wearable device may also be referred to as a wearable smart device, which is a general term of wearable devices that are intelligently designed and developed by applying wearable technology to daily wear, such as, glasses, gloves, watches, clothing and shoes. The wearable device is a portable device that is worn directly on the body or integrated into the user's clothes or accessories. The wearable device is not only a kind of hardware device, but also realizes powerful functions through software support, data interaction and cloud interaction. The generalized wearable smart device has full functions and a large size, and the generalized wearable smart device may realize complete or partial functions without relying on smart phones, such as smart watches or smart glasses, and the generalized wearable smart device only focus on certain application functions and need to be used in conjunction with other devices (such as, smart phones), such as, various smart bracelets and smart jewelry for monitoring physical signs.

It should be understood that FIG. 1 is only an example of the present disclosure and should not be construed as a limitation of the present disclosure. For example, FIG. 1 illustrates only one AP and two STAs by way of example, and in some embodiments, the communication system 100 may include multiple APs and other numbers of STAs, which are not limited in the embodiments of the present disclosure.

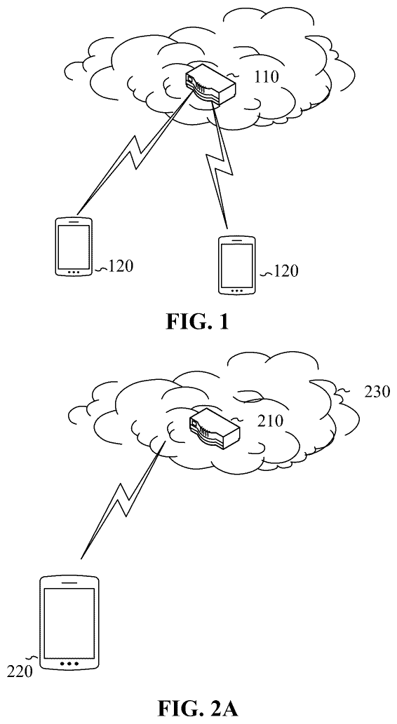

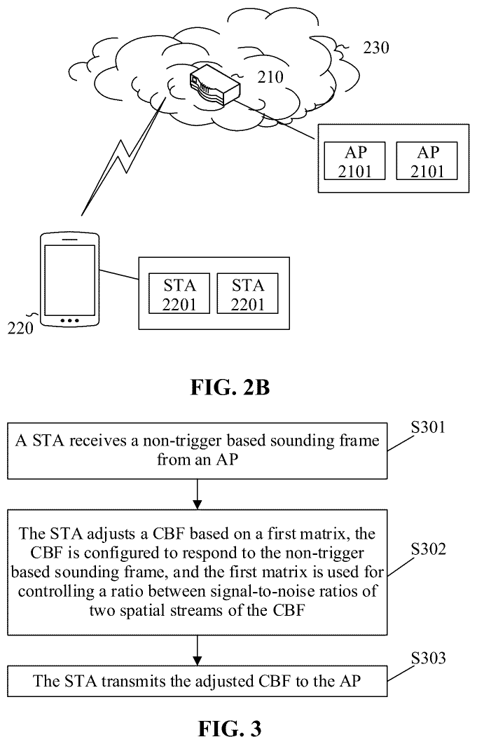

FIG. 2A is a schematic diagram illustrating an application scenario according to an embodiment of the present disclosure.

As illustrated in FIG. 2A, the communication system 200 may include: an AP multi-link device (MLD) 210 and a non-AP MLD 220. The AP MLD 210 is an electronic device capable of forming a wireless local area network 230 based on a transmitted signal. For example, the AP MLD 210 may be a router, a mobile phone having a hotspot function. The non-AP MLD 220 is an electronic device accessing the wireless local area network 230 formed by the AP MLD 210. For example, the non-AP MLD 220 may be a mobile phone, a smart washing machine, an air conditioner, an electronic lock, and the like. The non-AP MLD 220 communicates with the AP MLD 210 through the wireless local area network 230. The AP MLD 210 may be a soft AP MLD, a Mobile AP MLD, or the like.

As illustrated in FIG. 2B, in the communication system illustrated in FIG. 2A, the AP MLD 210 is affiliated with at least two APs 2101, and the non-AP MLD 220 is affiliated with at least two STAs 2201. Each of APs is connected with a respective STA in the non-AP MLD 220 through a respective link. An AP associated with the AP MLD may also be referred to as an affiliated AP of the AP MLD, an STA associated with the non-AP MLD may also be referred to as a non-AP STA affiliated with the non-AP MLD or an affiliated STA of the non-AP MLD.

In the embodiments of the present disclosure, the AP MLD 210 and the non-AP MLD 220 may be terminal devices. The terminal device may refer to as an access terminal, User Equipment (UE), a user unit, a user station, a mobile station, a mobile platform, a remote station, a remote terminal, a mobile device, a user terminal, a terminal, a wireless communication device, a user agent, or a user device. The access terminal may be a cellular telephone, a cordless phone, a session initiation protocol (SIP) phone, a wireless local loop (WLL) station, a personal digital processing (PDA) device, a handheld device with a wireless communication function, a computing device or other processing device connected to a wireless modem, a vehicle-mounted device, a wearable device, a terminal device in a 5th generation (5G) network, or a terminal device in a future evolved public land mobile network (PLMN) or the like.

The communication system 200 illustrated in FIG. 2A may further include a network device, and the network device may be an access network device that communicates with the terminal device. The access network device may provide communication coverage for a particular geographic area and may communicate with terminal devices located within the coverage.

FIG. 2A exemplarily illustrates one AP MLD and one non-AP MLD. In an embodiment, the wireless communication system 200 may include multiple non-AP MLDs accessing the wireless local area network 230, which is not limited in the embodiment of the present disclosure.

It is to be noted that FIG. 1, FIG. 2A, and FIG. 2B only illustrate systems to which the present disclosure is applied in the form of examples, and of course, the method of the embodiments of the present disclosure may also be applied to other systems. Furthermore, the terms “system” and “network” are often used interchangeably herein. In the present disclosure, the term “and/or” is only an association relationship describing associated objects and represents that three relationships may exist. For example, A and/or B may represent three conditions: i.e., independent existence of A, existence of both A and B and independent existence of B. In addition, the character “/” in the present disclosure generally indicates that previous and next associated objects form an “or” relationship. It is also to be understood that the term “indication” in embodiments of the present disclosure may be a direct indication, an indirect indication, or an indication of an associative relationship. For example, an indication of B by A may indicate that A directly indicates B, for example, B is obtained through A, or that A indirectly indicates B, for example, A indicates C and B is obtained through C, or that there is an association between A and B. It is also to be understood that the term “correspondence” in embodiments of the present disclosure may indicate a direct or indirect correspondence between the two elements, or may indicate an association between the two elements, or may indicate a relationship of indicating and being indicated, configuring and being configured, etc. It is also to be understood that the term “predefined” or “predefined rules” in embodiments of the present disclosure may be achieved by pre-storing corresponding codes, tables or other manners for indicating relevant information in devices (e.g., including a terminal device and a network device). The specific implementation is not limited in the present disclosure. For example, “predefined” may refer to those defined in a protocol. It is also to be understood that in this disclosure, “protocol” may refer to a standard protocol in the field of communication, which may include, for example, an IEEE 802.11 protocol, an LTE protocol, a NR protocol, and related protocols applied in a future communication system, which is not limited by the present disclosure.

In order to facilitate understanding of the technical solutions in the embodiments of the present disclosure, the technical solutions of the present disclosure are described in detail through specific embodiments below. The above relevant technology as optional solutions may be combined with the technical solutions of the embodiments in any way, and shall fall within the scope of protection of the present disclosure. The embodiments of the present disclosure include at least some of the following contents.

An embodiment of the present disclosure provides a method for wireless communication, which is applied to a STA. As illustrated in FIG. 3, the method includes the following operations.

At S301, an STA receives a non-trigger based (non-TB) sounding frame from an AP.

At S302, the STA adjusts a compressed beamforming feedback (CBF) based on a first matrix. The CBF is used to respond to the non-TB sounding frame, and the first matrix is used for controlling a ratio between signal-to-noise ratios (SNRs) of two spatial streams of the CBF.

At S303, the STA transmits the adjusted CBF to the AP.

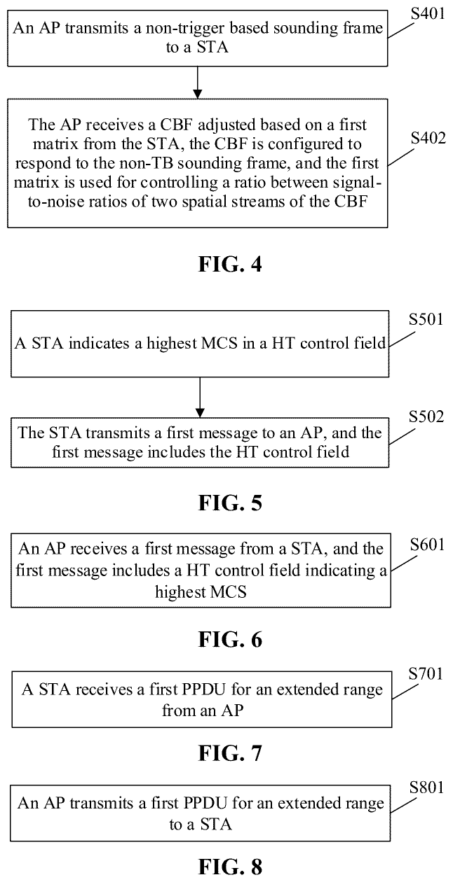

An embodiment of the present disclosure provides a method for wireless communication, which is applied to an AP. As illustrated in FIG. 4, the method includes the following operations.

At S401, an AP transmits a non-TB sounding frame to a STA.

At S402, the AP receives a CBF adjusted based on a first matrix from the STA. The CBF is used to respond to the non-TB sounding frame, and the first matrix is used for controlling a ratio between SNRs of two spatial streams of the CBF.

The method for wireless communication illustrated in FIG. 3 or FIG. 4 is further described below.

The AP may be understood as a Beamformer (BFer), and the STA may be understood as a Beeamformee (BFee).

The BFer transmits the non-TB sounding frame to the BFee. After receiving the non-TB sounding frame, the BFee adjusts the CBF based on the first matrix R to obtain the adjusted CBF and feeds the adjusted CBF back to the BFer.

The CBF sent by the BFee may be understood as a single-user (SU) CBF.

In the embodiments of the present disclosure, the CBF may be a beamforming feedback matrix V_{BF}. The adjusted CBF, that is, an optimized CBF, may be expressed as Equation (1).

$${V}_{r o t} = {V}_{B F} * R , \qquad Equation ( 1 )$$

where Vᵣₒₜ is the adjusted CBF.

In the embodiments of the present disclosure, the first matrix may be called a rotation matrix and is used for doing a power allocation across the two spatial streams of the CBF, thereby controlling the ratio between the SNRs of the two spatial streams. The ratio between the SNRs of the two spatial streams may be understood as a gap between different average SNRs from different spatial streams at a receiver side, and different spatial streams have different posterior signal-to-noise ratios (postSNRs) at the receiver side.

In the embodiments of the present disclosure, the STA adjusts the CBF through the first matrix and transmits the adjusted CBF to the AP, and the CBF received by the AP is the adjusted CBF based on the first matrix, thereby improving performance by controlling the ratio between the SNRs of the two spatial streams of the CBF using the first matrix.

In some embodiments, a range of values of elements in the first matrix is −1 to 1.

In some embodiments, the first matrix is determined based on a first parameter, and the first parameter is predefined or determined by the STA.

The first matrix may be expressed as

$$R = [ \begin{matrix}cos θ & sin θ \\ sin θ & - cos θ\end{matrix} ] ,$$

where the first parameter is θ.

If θ=45 degrees, then

$$R = [ \begin{matrix}1 & 1 \\ 1 & - 1\end{matrix} ] * \frac{1}{\sqrt{2}} ;$$

if θ=0 degrees, then

$$R = [ \begin{matrix}1 & 0 \\ 0 & 1\end{matrix} ] ,$$

such that Vᵣₒₜ=V_{BF}.

In the embodiments of the present disclosure, given an estimated channel H, a beamforming matrix V_{BF} of a current feedback obtained based on singular value decomposition (SVD) may be expressed as Equation (2):

$$SVD ( H ) \to {V}_{BF} = [ \begin{matrix}{V}_{1} & {V}_{2}\end{matrix} ] . \qquad Equation ( 2 )$$

Taking

$$R = [ \begin{matrix}cos θ & sin θ \\ sin θ & - cos θ\end{matrix} ]$$

as an example, based on Vᵣₒₜ, the post SNR of the first spatial stream (i.e., 1^{st} spatial stream) may be expressed as Equation (3).

$${H}_{1 st} = U * S * {[ {V}_{1} {V}_{2} ]}^{H} * ( {V}_{1} * cos θ + {V}_{2} * sin θ ) = U * S * [ \begin{matrix}cos θ \\ sin θ\end{matrix} ] \to {PostSNR}_{1 st} = \frac{{s}_{1}^{2} {cos}^{2} θ + {s}_{2}^{2} {sin}^{2} θ}{{N}_{0}} . \qquad Equation ( 3 )$$

The post SNR of the second spatial stream (i.e., 2^{nd} spatial stream) may be expressed as Equation (4).

$${H}_{2 ed} = U * S * {[ {V}_{1} {V}_{2} ]}^{H} * ( {V}_{1} * sin θ + {V}_{2} * cos θ ) = U * S * [ \begin{matrix}sin θ \\ - cos θ\end{matrix} ] \to {PostSNR}_{2 ed} = \frac{{s}_{1}^{2} {sin}^{2} θ + {s}_{2}^{2} {cos}^{2} θ}{{N}_{0}} . \qquad Equation ( 4 )$$

From Equation (3) and Equation (4), it may be determined that the first matrix is doing the power allocation across the two spatial streams of V_{BF}, and the ratio between the SNRs of the two spatial streams is controlled by θ.

In some embodiments, if a first parameter is determined by the STA, the method for wireless communication illustrated in FIG. 3 further includes the following operation.

The STA transmits the first parameter to the AP. The first parameter is used by the AP for determining a beamforming matrix.

For the AP, if the first parameter is determined by the STA, the method for wireless communication illustrated in FIG. 4 further includes the following operation.

The AP receives the first parameter from the STA. The first parameter is used by the AP for determining a beamforming matrix.

The BFee may transmit θ to the BFer, so that the BFer knows θ.

Since θ is also known by the BFer, the BFer can do an inverse operation on Equation (1) and derive the V_{BF} which is optimized for single stream beamforming. Then the BFer will have a beamforming feedback optimized for both a single stream and multi-streams. The BFer can choose a best fit depending on a decision of its own rate adaptation algorithm.

In some embodiments, the method further includes the following operation.

The STA receives beamformed data from the AP, and the number of spatial streams of the beamformed data is a first number.

In some embodiments, the method includes the following operation.

The AP transmits beamformed data to the STA, and the number of spatial streams of the beamformed data is a first number.

First data is the beamformed data (i.e., Bfed data) sent by the AP based on the beamforming feedback, that is, the first data is the Bfed data transmitted based on the number of spatial streams of the received CBF.

The BFer will transmit BFed data based on the number of spatial streams fed back by the BFee, but the BFed data transmission is based on BFer's rate adaptation i.e., per BFer's decision.

In an embodiment, the first number is 1 or 2.

In some embodiments, determination of the first number includes one of the following options.

Option 1: the first number is determined by a second parameter indicated by the AP to the STA.

Option 2: the first number is indicated by a CBF transmitted from the STA to the AP.

Option 3: the first number is a number of spatial streams used for a preferred feedback selected from multiple CBF candidates, and different CBF candidates have different numbers of spatial streams.

For option 1, the BFer transmits the second parameter to the BFee for indicating the first number, and the first number is the preferred number of columns of the BFer. The BFee determines the first number based on the received second parameter.

In an embodiment, the second parameter is a parameter of the number of columns (Nc). In such case, the parameter of the number of columns (Nc) indicates the preferred number of columns of the BFer.

The preferred number of columns may be described as the preferred number of streams or the preferred number of spatial streams.

In some embodiments, the second parameter is carried in a null data packet announcement (NDPA) frame sent by the AP to the STA.

In an embodiment, in the NDPA frame sent by the BFer, the parameter of the number of columns (Nc) in a user information field of the NDPA (addressed to the BFee) shall indicate the preferred number of columns of the BFer.

For option 2, the BFee indicates the preferred number of columns.

In an embodiment, if the BFer doesn't indicate the preferred number of columns (Nc), the BFee shall indicate the preferred number of columns.

In an embodiment, the BFee indicates the preferred number of spatial streams in a MIMO control field of the CBF.

Option 2 recommends the BFer to transmit BFed data with a specific number of streams where the BFee optimized for in the CBF.

In some embodiments, spatial stream data of the CBF is the first number.

In option 1, the BFee optimizes the CBF based on the preferred number of columns indicated by the BFer. In this case, option 1 requires the BFee to optimize the CBF based on the preferred number of streams indicated by the BFer.

In option 2, the BFee indicates the preferred number of columns, which is also the number of spatial streams in an SU CBF frame that the BFee optimized for. The BFer, after receiving the SU CBF, should transmit the BFed data with the number of spatial streams indicated in the MIMO control field of the SU CBF frame.

In option 3, the BFee feeds back multiple candidates of the SU CBF (i.e., the CBF candidates) based on the number of spatial streams the BFee supported. The BFer may choose to use a CBF preferred by the AP based on its own rate adaptation. Different CBF candidates have different numbers of spatial streams.

In an example, the BFee has two antennas, then the BFee will feed back an SU compressed beamforming (BFing) matrix optimized for one spatial stream, and also will feed back an SU compressed BFing matrix optimized for two spatial streams, and the BFer may choose to use the preferred feedback of the BFer based on its own rate adaptation.

It is to be understood that the CBF candidate may also be described as a feedback candidate.

In some embodiments, the CBF candidates having different numbers of spatial streams are carried in one or more action frames.

In some embodiments, the action frame carrying a CBF candidate further carries a number of spatial streams of the CBF candidate.

In an embodiment, the number of CBF candidates shall be indicated in the MIMO control field in the action frame used to carry the feedback.

In an example, a feedback type (bit 14 to bit 16, i.e., B14 to B16) of the MIMO control field in the action frame has one reserved value which can be used to indicate the multiple CBF candidates. A value of 0 for the feedback type indicates an SU, a value of 1 for the feedback type indicates a multi-user (MU), a value of 2 for the feedback type indicates a channel quality indicator (CQI), and a value of 3 for the feedback type indicates the reserved value.

An embodiment of the present disclosure provides a method for wireless communication, which is applied to an STA. As illustrated in FIG. 5, the method includes the following operations.

At S501, an STA indicates a highest modulation and coding scheme (MCS) in a high throughput (HT) control field.

At S502, the STA transmits a first message to the AP, and the first message includes the HT control field.

An embodiment of the present disclosure provides a method for wireless communication, which is applied to an AP. As illustrated in FIG. 6, the method includes the following operation.

At S601, an AP receives a first message from the STA, and the first message includes a HT control field indicating a highest MCS.

It should be noted that the method for wireless communication illustrated in FIG. 5 and/or FIG. 6 may be implemented independently of the method for wireless communication illustrated in FIG. 3 and/or FIG. 4, or in combination with the method for wireless communication illustrated in FIG. 3 and/or FIG. 4.

The method for wireless communication illustrated in FIG. 5 or FIG. 6 is further described below.

The AP may be understood as a transmitter, and the STA may be understood as a receiver.

The transmitter receives, based on the HT control field, the highest MCS that the receiver reports and can support, thereby informing the transmitter of the highest MCS that the receiver can support, based on the HT control field.

The highest MCS may also be described as a maximum MCS.

In an embodiment, the HT control field may be included in a quality-of-service (QoS) frame or a QoS null frame.

The method for wireless communication provided by the embodiments of the present disclosure can provide timely changes to the maximum supported MCS to adapt rapidly for adjacent channel interference (ACI) scenarios.

In some embodiments, the highest MCS is indicated by a first field in a high efficiency (HE) variant of the A-control field in the HT control field.

In some embodiments, the first field is an EHT OM control subfield or a defined control information subfield.

The EHT OM control subfield is a field that already exists in the HE variant.

The defined control information subfield is a newly added field in the HE variant.

If the first field is the EHT OM control subfield, a purpose indicating the highest MCS is added to a purpose of the EHT OM control subfield.

If the first field is a control information subfield, a new control information subfield is added in the HE variant of the HT control field to indicate the maximum MCS supported.

In some embodiments, the highest MCS is indicated by a reserved field in the EHT OM control subfield.

The reserved field of the EHT OM control subfield is the reserved bits (B3 to B5). In an embodiment, part or all of the reserved bits included in the reserved field are used to indicate the highest MCS.

In an example, one or two reserved bits are used to indicate the highest MCS.

In the case that the highest MCS is indicated by the reserved field in the EHT OM control subfield, the reserved bit(s) is repurposed to indicate the highest MCS.

In some embodiments, a control identifier with a reserved value in the A-control field indicates adding the defined control information subfield in the HE variant.

When a value of the control identifier in the A-control field is a reserved value, the control identifier is used to indicate adding the control information subfield into the HE variant.

In the case of adding a control information field into the HE variant, the control information field indicates the highest MCS that the transmitter can support.

In an embodiment, the reserved value of the control identifier is one of 10 to 14.

In an example, when the value of the control identifier is 10, the control identifier is used to indicate adding the control information subfield into the HE variant.

In the method for wireless communication provided by the embodiments of the present disclosure, a device category of the STA is a first category or a second category. A device of the first category only supports a bandwidth of 20 MHz, and a device of the second category supports a bandwidth greater than or equal to 80 MHz.

An STA may be described as a WiFi device, and the WiFi devices are categorized based on capabilities of the WiFi devices. The categories of the WiFi devices include the first category and the second category. A bandwidth of devices in the first category (i.e., a supported bandwidth) is 20 MHz. A bandwidth of devices in the second category (i.e., a supported bandwidth) is greater than or equal to 80 MHz.

In the embodiments of the present disclosure, the device of the first category may be described as a 20 MHz-only device.

In some embodiments, the capabilities of the device in the first category further include one or more of: the number of supported spatial streams is greater than or equal to 1, and a supported MCS is greater than or equal to MCS7.

In some embodiments, the capabilities of the device in the second category also include one or more of the following: the number of supported spatial streams is greater than or equal to 1, and the supported MCS is greater than or equal to MCS9.

In the embodiments of the present disclosure, compared with the device of the second category, the device of the first category has a lower supported bandwidth (BW), number of spatial streams and highest MCS.

In some embodiments, the device of the first category disables support of a first resource unit (RU) or support of both the first RU and a second RU. The first RU is a RU including 26 subcarriers, and the second RU is a RU including 52 subcarriers.

The first RU may be described as a 26-tone RU, similarly, the second RU may be described as a 52-tone RU. The RU referred to in the embodiments of the present disclosure also includes: a 106-tone RU (i.e., a RU including 106 subcarriers), and a 242-tone RU (i.e., a RU including 242 subcarriers).

The device of the first category disables support of the 26-tone RU, and only keeps support of the 52-tone RU, the 106-tone RU and the 242-tone RU.

The device of the first category disables support of both 26-tone RU and 52-tone RU, and only keeps support of the 106-tone RU and the 242-tone RU.

In the embodiments of the present disclosure, the device of the first category supports a smaller number of RU combinations in one 20 MHz subchannel, which can reduce the number of entries for RU allocation indication.

In some embodiments, a RU allowed by the device of the first category is indicated by a second number of bits. The second number is less than or equal to 3.

In an example, in a signal field, only 1 or 2 or 3 bits are used to indicate a location of the RU for 106-tone, 52-tone, or 242-tone.

In an example, when only the 106-tone RU and the 242-tone RU are allowed, the RU allocation uses 3 entries (2 bits) to indicate a lower 106-tone RU, a higher 106-tone RU or 242-tone RU.

In the embodiments of the present disclosure, the RU allocation indication is simplified, significantly reducing complexity of RU allocation signal parsing.

In some embodiments, the device of the first category is disallowed to participate a wider bandwidth orthogonal frequency division multiple access (OFDMA) physical layer protocol data unit (PPDU) reception, and/or the device of the first category participates the wider bandwidth OFDMA PPDU reception.

In some embodiments, the device of the first category uses 16 microseconds (us) extension.

In an embodiment, the device of the first category always uses 16 us packet extensions regardless of RU size and MCS.

In some embodiments, an integer number of orthogonal frequency division multiplexing (OFDM) symbols is padded for the device of the first category in pre-forward error correction (FEC) padding.

In the FEC padding, it always pads the integer number of OFDM symbols instead of a quarter number of OFDM symbols, that is, always sets a_{init,u}=4.

In some embodiments, a low-density parity check code (LDPC) extra symbol is one whole extra OFDM symbol for the device of the first category.

If the LDPC extra symbol is required in rate matching, one whole extra OFDM symbol is always being added instead of a quarter OFDM symbol.

When adding the whole extra OFDM symbol, the following Equation (5) and Equation (6) hold:

$${N}_{avbits , u} = \{ \begin{matrix}{N}_{avbits , u} - 2 {N}_{CBPS , u} , & if {a}_{init} = 3 \\ {N}_{avbits , u} + 2 {N}_{CBPS , u} & otherwise\end{matrix} ; \qquad Equation ( 5 )$$

$${N}_{SYM} = {N}_{SYM , init} + 1 , a = 4. \qquad Equation ( 6 )$$

In the embodiments of the present disclosure, the whole limitation on the extra OFDM symbol simplifies the LDPC rate matching procedure for the devices of the first category.

In some embodiments, for a STA, if the device category of the STA is the first category, as illustrated in FIG. 7, the method further includes the following operation.

At S701, the STA receives a first PPDU for an extended range (ER) from the AP.

In some embodiments, for the AP, if the device category of the STA is the first category, as illustrated in FIG. 8, the method further includes the following operation.

At S801, the AP transmits a first PPDU for an ER to the STA.

In some embodiments, in a preamble of the first PPDU, the second (i.e., 2^{nd}) OFDM symbol after a repeated legacy signal field (RL-SIG) is quadrature phase shift keying (Q-PSK) modulated; and/or a legacy signal field (L-SIG) and a universal signal field (U-SIG) are repeated in the time domain.

The first PPDU may also be described as an ER PPDU or a PPDU for the ER.

In the embodiments of the present disclosure, a new PPDU format for the ER is defined. The preamble for the ER PPDU includes the following properties:
1. The 2^{nd} OFDM symbol after the RL-SIG shall be Q-PSK modulated to enable a legacy device to detect the PPDU as the ER PPDU;
2. The L-SIG and U-SIG field shall be repeated several times in the time domain to achieve a longer range.

In an example, the L-SIG is repeated 4 times (L-SIG, RL-SIG, RL-SIG_1, RL-SIG_2), the U-SIG field is also repeated by a repeated U-SIG field (R-U-SIG).

In an example, the 2^{nd} symbol after RL-SIG is still quadrature binary phase shift keying (QBPSK), while the structure of U-SIG-1, R-U-SIG-1, U-SIG-2, and R-U-SIG2 maintains. The legacy device can decode the U-SIG field and pass version independent information to Media Access Control (MAC).

In some embodiments, the number of repetitions in R-U-SIG is predefined.

In some embodiments, the preamble of the first PPDU includes a defined second field for indicating that a PPDU in which the defined second field is located is the first PPDU.

The second field may be defined as a U-SIG and L-SIG boosting field.

The second field is added into the ER PPDU in order to boost performance for the STA that can recognize the ER PPDU.

In some embodiments, the second field includes a time domain repeated version of the L-SIG and U-SIG.

The second field includes the time domain repeated version of the L-SIG and U-SIG to achieve combination gain and boost performance for decoding or PPDU format detection.

It is to be understood that in the embodiments of the present disclosure, the following contents may be implemented independently or in combination with other contents:
Content 1: contents about the first matrix as illustrated in FIG. 3 and FIG. 4;
Content 2: contents about indication of the highest MCS as illustrated in FIG. 5 and FIG. 6;
Content 3: contents about device categories.

The method for wireless communication provided by the embodiments of the present disclosure is further described below.

### Embodiment 1

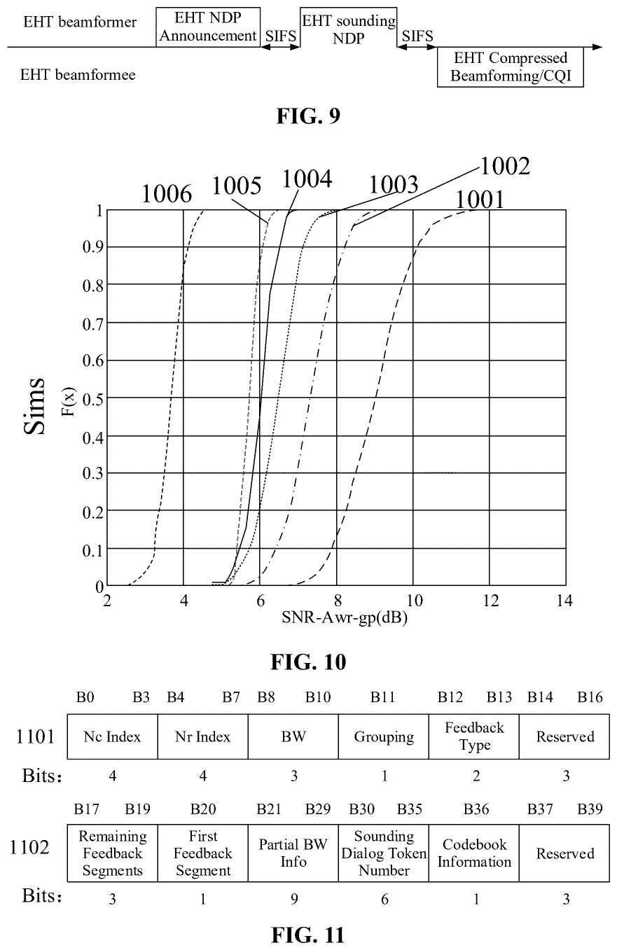

A non-TB sounding sequence for compressed single-user (SU) beamforming feedback is illustrated in FIG. 9.

An EHT BFer transmits an EHT NDPA frame to an EHT BFee (to announce the start of beamforming), and after a short interframe space (SIFS), transmits an EHT sounding NDPA frame to the BFee. The EHT BFee transmits an EHT compressed beamforming or a CQI to the EHT BFee.

In the NADP frame of a non-TB sounding procedure, the BFer doesn't specify how many spatial streams the BFee is supposed to feedback, that is, does not specify a parameter Nc (the parameter Nc is used to indicate the number of spatial streams, i.e., the number of columns in a beamforming (i.e., BFing) vector/matrix in the SU compressed BFing feedback, to feedback). Instead, the BFer will leave flexibility to the BFee. Each column in the feedback matrix corresponds to a respective spatial stream.

As an example, for a BFee with two antennas, the BFee can chose to feedback either one or two spatial streams per BFee's decision. Then the BFer will transmit beamformed (BFed) data based on the number of spatial streams feedback by the Bfee but BFed data transmission is based on BFer's rate adaptation, i.e., per BFer's decision.

There are two problems with the above solution.

### Problem 1

If a BFee has more than one antenna, eigen values (corresponding to each stream), which are related to post SNRs and feedbacks to the BFer will be different across multiple streams. It means that different spatial streams will have different post SNRs at the receiver side.

Define the gap between two spatial streams as Equation (7).

$$SNR\_Avr \_gap = Average SNR\_SS1 / Average SNR\_SS2 ( in dB ) . \qquad Equation ( 7 )$$

FIG. 10 illustrates a distribution of a gap between average SNRs from two spatial streams in a CBF. 1001 corresponds to a 2×2 channel, 1002 corresponds to a 2×4 channel, 1003 corresponds to a 2×8 channel, 1004 corresponds to a 2×16 channel, 1005 corresponds to a 2×16 channel with two lambdas receiving, and 1006 corresponds to a 2×16 channel with two lambdas transmitting. It can be observed based on FIG. 10 that for 50% value of the gap for 2×4 channel is approximately 7.5 dB. Given that a single MCS is used across multiple spatial streams in current WiFi standards, performance degradation is expected comparing with adapting different MCS to different streams.

### Problem 2

From the aforementioned background, it is obvious that the BFer may transmit BFed data with a number of spatial streams that doesn't match the number of streams in the SU compressed feedback from the BFee. For instance, the BFee always conducts the feedback with two spatial streams, but the BFer may use only one stream for data transmission based on its own rate adaptation algorithm. Hence, if the BFee optimizes the compressed BFing feedback for two spatial streams but the BFer only transmits with one spatial stream, potential performance degradation can be expected.

### Solution for Problem 1

In order to combat a postSNR gap between two spatial streams with a single MCS across multiple streams, it is proposed to change the CBF for two spatial streams. More than two streams are out of the scope of this disclosure.

Given the estimated channel H, as illustrated in Equation (2), the beamforming matrix V_{BF} of the current feedback is obtained based on the SVD:

$$SVD ( H ) \to {V}_{BF} = [ \begin{matrix}{V}_{1} & {V}_{2}\end{matrix} ] . \qquad Equation ( 2 )$$

The two vectors V₁ and V₂ in the feedback correspond to the two eigen values of the estimated channel H.

The proposal is instead of feedback V_{BF} in Equation (2), the BFee feeds back Vᵣₒₜ defined in Equation (1).

$${V}_{rot} = {V}_{BF} * R , \qquad Equation ( 1 )$$

where

$$R = [ \begin{matrix}cos θ & sin θ \\ sin θ & - cos θ\end{matrix} ] .$$

The value θ is adjustable by the BFee.

For instance, if 0=45 degrees, then

$$R = [ \begin{matrix}1 & 1 \\ 1 & - 1\end{matrix} ] * \frac{1}{\sqrt{2}} ;$$

if θ=0 degrees, then

$$R = [ \begin{matrix}1 & 0 \\ 0 & 1\end{matrix} ] ,$$

such that Vᵣₒₜ=V_{BF}.

With the proposed feedback, the postSNR of the 1^{st} spatial stream is:

$${H}_{1 st} = U * S * {[ {V}_{1} {V}_{2} ]}^{H} * ( {V}_{1} * cos θ + {V}_{2} * sin θ ) = U * S * [ \begin{matrix}cos θ \\ sin θ\end{matrix} ] \to {PostSNR}_{1 st} = \frac{{s}_{1}^{2} {cos}^{2} θ + {s}_{2}^{2} {sin}^{2} θ}{{N}_{0}} . \qquad Equation ( 3 )$$

The postSNR of the 2^{nd} spatial stream is:

$${H}_{2 ed} = U * S * {[ {V}_{1} {V}_{2} ]}^{H} * ( {V}_{1} * sin θ + {V}_{2} * cos θ ) = U * S * [ \begin{matrix}sin θ \\ - cos θ\end{matrix} ] \to {PostSNR}_{2 ed} = \frac{{s}_{1}^{2} {sin}^{2} θ + {s}_{2}^{2} {cos}^{2} θ}{{N}_{0}} . \qquad Equation ( 4 )$$

From Equation (3) and Equation (4), it can be observed that the rotation matrix R is essentially doing the power allocation across the two spatial streams and the ratio between the SNRs of the two spatial streams is controlled by θ.

Table 1 is simulations that verify the proposed feedback can provide significant gain. Note that the simulations in table 1 chose θ=45 degrees as an example, and Nss in table 1 is the number of spatial streams.

TABLE 1
Performance gain with the proposed feedback scheme

| | | | | | Sensitivity | | Gain(dB) |
|---|---|---|---|---|---|---|---|
| Nrx | Ntx | Bw(MHz) | MCS | Nss | SVD | Rot | Rot-SVD |
| 2 | 2 | 20 | 0 | 2 | 15.577 | 10.421 | −5.156 |
| 2 | 2 | 20 | 4 | 2 | 28.996 | 25.048 | −3.948 |
| 2 | 2 | 20 | 7 | 2 | 37.109 | 34.715 | −2.394 |
| 2 | 2 | 20 | 9 | 2 | 41.577 | 41.030 | −0.547 |
| 2 | 2 | 20 | 11 | 2 | 47.637 | 47.617 | −0.02 |
| 2 | 4 | 80 | 0 | 2 | 7.984 | 4.850 | −3.134 |
| 2 | 4 | 80 | 4 | 2 | 20.886 | 18.488 | −2.398 |
| 2 | 4 | 80 | 7 | 2 | 28.716 | 26.473 | −2.243 |
| 2 | 4 | 80 | 9 | 2 | 32.771 | 32.094 | −0.677 |
| 2 | 4 | 80 | 11 | 2 | 38.266 | 37.863 | −0.403 |
| 2 | 8 | 160 | 0 | 2 | 3.468 | 1.862 | −1.606 |
| 2 | 8 | 160 | 4 | 2 | 15.414 | 13.440 | −1.974 |
| 2 | 8 | 160 | 7 | 2 | 22.963 | 21.643 | −1.32 |
| 2 | 8 | 160 | 9 | 2 | 27.520 | 26.879 | −0.641 |
| 2 | 8 | 160 | 11 | 2 | 33.028 | 32.927 | −0.101 |

### Solution for Problem 2:

It has also been verified that if the solution in problem 1 is conducted to optimize the SU compressed BFing feedback, then the performance degradation is observed if the BFee feeds back two spatial streams, but the AP chose to transmit only one spatial stream by using the first column of the feedback matrix (i.e., the 1^{st} column of Vᵣₒₜ).

The present disclosure proposes the following three options to solve this issue.

Option 1: in the NDPA frame send by the BFer, the parameter of the number of columns (Nc) in the user info filed of the NDPA (addressed to the BFee) shall indicate the preferred number of columns of the BFer. In addition, the BFee shall use the same number of Nc in the MIMO control field in the SU CBF frame.

This option mandates the BFee to optimize the SU CBF based on the preferred number of streams indicated by the BFer.

Option 2: if the BFer doesn't indicate the number of columns (Nc) in the user info filed of the NDPA (addressed to the BFee), the BFee shall indicate the preferred number of spatial streams (in the MIMO control field), which is also the number of spatial streams in the SU CBF frame that the BFee optimized for. The BFer, after receiving the SU CBF, should transmit the Bfed data with the number of spatial streams indicated in the MIMO control field of the SU CBF frame.

This option recommends the BFer to transmit BFed data with a specific number of streams where the BFee optimized for in the SU CBF.

Option 3: the BFee feeds back multiple candidates of the SU CBF based on the number of spatial streams the BFee supported. For instance, the BFee has two antennas, then the BFee will feed back the SU compressed BFing matrix optimized for one spatial stream, and also will feed back the SU compressed BFing matrix optimized for two spatial streams. The BFer may choose to use the preferred feedback of the AP based on its own rate adaptation.

The feedback of different number of spatial streams may be carried in one or multiple action frames.

The number of feedback candidates shall be indicated in the MIMO control field in the action frame used to carry the feedback. As an example, using an EHT MIMO control field as illustrated in FIG. 11 to illustrate option 3. The feedback type has one reserved value which can be used to indicate multi-candidates' feedback. The reserved bits (B14 to B16) can be used to indicate how many candidates are included in the feedback.

The value of the feedback type is set to 0 for the SU; the value of the feedback type is set to 1 for the MU; the value of the feedback type is set to 2 for the CQI; and the value 3 of feedback type is the reserved value.

Option 4: the BFee optimizes the SU CBF based on Equation (1) if the number of streams to feed back is greater than 1. θ can be either predefined, e.g., set θ=45 degrees, or θ can be chosen by the BFee and fed back to the BFer.

The BFer will have the feedback optimized for multiple streams directly from the CBF. Since θ is also known by the BFer, the BFer can do the inverse operation on Equation (1) and derive the V_{BF} which is optimized for single stream beamforming. Then the BFer will have the beamforming feedback optimized for both the single stream and the multi-streams. The BFer can choose the best fit depending on the decision of its own rate adaptation algorithm.

In the method for wireless communication provided in the Embodiment 1:
the BFee receives the non-TB sounding sequence from the BFer;
the BFee adjusts the CBF in response to the received non-TB sounding sequence based on

$$R = [ \begin{matrix}cos θ & sin θ \\ sin θ & - cos θ\end{matrix} ] ,$$

where a value of θ is determined by the BFee; and
the BFee transmits the adjusted CBF to the BFer.

### Embodiment 2

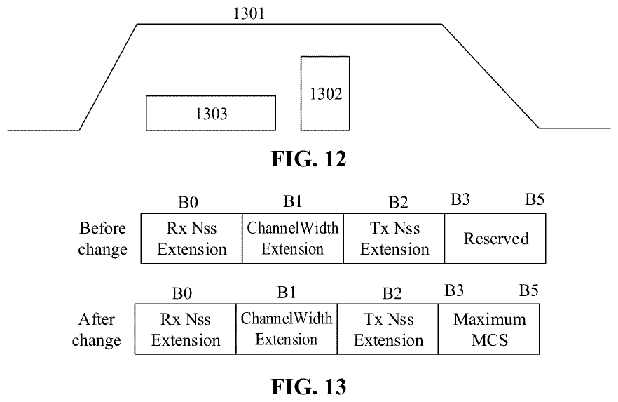

There is an ACI problem in the related art. As illustrated in FIG. 12, the interested channel 1303 stands for the signal addressed to the receiver, which is supposed to be received and detected. The ACI 1302 is whatever interference that cannot be filtered out by an analog filter which is usually very wide.

Taking WIFI transmission as an example, ACI and WIFI are receiving signal under the ACI.

A WiFi device usually reports its own capability on the maximum supported MCS during an association with an AP. This capability is evaluated without considering the ACI. For instance, a mainstream station (STA) can support up to 1024QAM or even 4096QAM. However, with the presence of ACI, it's very likely that the highest MCS cannot be achieved. The ACI may have a random pattern in both the time domain and frequency domain. i.e., come and go very fast, random in time, and unpredictable in frequency domain channels.

Based on those facts, it's not reasonable to ask the STA to negotiate the maximum MCS with an association or re-association procedure because the frame exchange overhead is large. Instead, the operating mode (OM) control or EHT OM control can be sent much more frequently than the association or re-association.

Some existing works rely on AP's link adaptation, which is one workaround. However, based on a test, the AP could be aggressive to boost the throughput without the knowledge of what's happening at the STA side. It means AP's like adaptation may introduce a large number of retransmissions by using a high MCS to boost throughput if the ACI goes away in a short term and comes back.

The present disclosure focuses on the OM control field to inform the transmitter of the highest MCS that a receiver can support. Two options are proposed.

Option 1: the current EHT OM control subfield in the HE variant of the A-control field in the HT control field is illustrated in FIG. 13. There are 3 bits reserved (B3 to B5). The proposal is to repurpose the reserved bits to indicate the highest MCS as illustrated in FIG. 13.

Without loss of generality, an example of the coding of B3 to B5 is illustrated in Table 2. Note that the three reserved bits are not necessarily used up. One or two bits may be used to indicate the maximum MCS.

TABLE 2
Example of definition of maximum MCS

| Indication information | MCS index of maximum MCS |
|---|---|
| 000 | MCS 7 |
| 001 | MCS 4 |
| 010 | MCS 9 |
| 011 | MCS 2 |
| 100 | MCS 0 |
| Other entries | Reserved |

Each MCS index actually corresponds to a physical transmission rate under a set of parameters.

Option 2: A new control information subfield is added in the HE variant of the HT control field to indicate the maximum MCS supported. Table 3 illustrates current control information subfields. The proposal is to recycle one of the reserved control ID values from 10-14 as the new control information subfield to indicate the maximum supported MCS.

For instance, control ID coding in the A-control field is illustrated in Table 3. Table 3 uses a reserved entry 10 to define the new control information subfield. The definition of the 3 bits can reuse the definition of Table 2.

TABLE 3
Example of definition of control ID coding

| Control ID | | Length of Control |
|---|---|---|
| value | Meaning | Information (bits) |
| 0 | Triggered response scheduling | 26 |
| | (TRS) | |
| 1 | Operating mode (OM) | 12 |
| 2 | HE link adaptation (HLA) | 26 |
| 3 | Buffer status report (BSR) | 26 |
| 4 | UL power headroom (UPH) | 8 |
| 5 | Bandwidth query report | 10 |
| | (BQR) | |
| 6 | Command and status (CAS) | 8 |
| 7 | EHT operating mode (EHT | 6 |
| | OM) | |
| 8 | Single response scheduling | 10 |
| | (SRS) | |
| 9 | AP assistance request (AAR) | 20 |
| 10-14 | Reversed | |
| 15 | Ones need expansion | 26 |
| | surely(ONES) | |

As illustrated in Table 3, when the control ID of the A-control field is 10, the new control information subfield is added into the HE variant of the HT control field.

The benefit of using the HT control field to piggyback the information, comparing with re-association, is that the HT control field can be included in the QoS frame, or the QoS null frame, which can provide timely changes to the maximum supported MCS to adapt rapidly for the ACI scenarios.

In the method for wireless communication provided in the Embodiment 2:
a receiving device indicates the highest MCS in the HT control field; and
the receiving device transmits the first message to a transmitting device, where the HT control field of the first message includes the highest MCS.

### Embodiment 3

Low-cost devices (for instance, 20 MHz-only devices) could be momentum to push WiFi evolving for the next generation. However, the existing WiFi standards development focuses on the optimization of a wider bandwidth (e.g., >=80 MHz). Devices only operating at 20 MHz are designed to accommodate the coexistence with wider bandwidth devices. The present disclosure proposes several aspects to optimize the 20 MHz-only devices.

1. Categorize the WiFi devices based on their capabilities. For instance, two categories are defined as illustrated in the Table 4 below:

TABLE 4
Example of device category

| Category | Capabilities |
|---|---|
| A | Bandwidth >= 80 MHz; Supported streams >= 1; |
| | Supported MCS >= MCS9 |
| B | Bandwidth = 20 MHz; Supported streams >= 1; |
| | Supported MCS >= MCS7 |

Category B has a lower supported bandwidth (BW), number of spatial streams and highest MCS.

2. Comparing with wider bandwidth devices, the smaller number of RU combinations is supported in one 20 MHz subchannel. In particular, the present disclosure is used in telecommunication devices whose signal bandwidth is 20 MHz.

Table 5 below is copied from a protocol and shows supported RUs in 20 MHz.

TABLE 5
Example of RU

| RU type | RU index and subcarrier range | | | | |
|---|---|---|---|---|---|
| 26-tone | RU1 | RU2 | RU3 | RU4 | RU5 |
| RU | (−121:−96) | (−95:−70) | (−69:−43) | (−42:−17) | (−16:−4, 4:16) |
| | RU6 | RU7 | RU8 | RU9 | |
| | (17:42) | (43:68) | (70:95) | (96:121) | |
| 52-tone | RU1 | RU2 | RU3 | RU4 | |
| RU | (−121:−70) | (−68:−17) | (17:68) | (70:121) | |

| | | |
|---|---|---|
| 106-tone | RU1 | RU2 |
| RU | (−121:−17) | (17:121) |

| | |
|---|---|
| 242-tone | RU1 |
| RU | (−121:−121) |

In some embodiments, the embodiments of the present disclosure propose to:
1) disable the support of the 26-tone RU, and only keep the support of the 52-tone RU, 106-tone RU and 242-tone RU; or
2) disable the support of both the 26-tone RU and the 52-tone RU, and only keep the support of the 106-tone RU and the 242-tone RU.

In comparison with other approaches, the present disclosure reduces the number of entries for the RU allocation indication. For example, the second proposal simplifies the RU allocation indication. In the signal field, only 1 or 2 or 3 bits are used to indicate the location of the RU for 106-tone, 52-tone, or 242-tone. For instance, when only the 106-tone RU and the 242-tone RU are allowed, the RU allocation uses 3 entries (2 bits) to indicate the lower 106-tone RU, the higher 106-tone RU or 242-tone RU.

The 26-tone RU may be understood as a RU including 26 subcarriers.

3. In some other embodiments, the embodiments of the present disclosure propose to:
a. disallow the 20 MHz-only device to participate the OFDMA PPDU reception; and/or
b. optionally support to participate the wider bandwidth OFDMA PPDU reception.

In comparison with other approaches, this simplification significantly reduces the complexity of the RU allocation signal parsing.

4. In yet other embodiments, the embodiments of present disclosure propose to always use 16 us packet extension regardless of the RU size and the MCS.

5. In the FEC padding, it is proposed to always pad to an integer number of OFDM symbols instead of the quarter number of OFDM symbols, i.e., always set a_{init,u}=4 regardless of N_{excess,u}. a_{init,u} may be expressed to Equation (8).

$${a}_{init , u} = \{ \begin{matrix}4 , & if {N}_{Excess , u} = 0 \\ min ( ⌈ \frac{{N}_{Excess , u}}{{N}_{DBPS , short , u}} ⌉ , 4 ) , & otherwise\end{matrix} . \qquad Equation ( 8 )$$

6. If the LDPC extra symbol is required in the rate matching, one whole extra OFDM symbol is always being added instead of a quarter OFDM symbol.

Equation (9) and Equation (10) are proposed.

$${N}_{avbits , u} = \{ \begin{matrix}{N}_{avbits , u} + {N}_{CBPS , u} - 3 {N}_{CBPS , short , u} , & if {a}_{init} = 3 \\ {N}_{avbits , u} + {N}_{CBPS , short , u} & otherwise\end{matrix} ; \qquad Equation ( 9 )$$

$$\{ \begin{matrix}{N}_{SYM} = {N}_{SYM} + 1 and a = 1 , & if {a}_{init} = 4 \\ {N}_{SYM} = {N}_{SYM , init} and a = {a}_{init} + 1 , & otherwise\end{matrix} . \qquad Equation ( 10 )$$

In equation (9), N_{cbps,short,u} is replaced with N_{cbps,u}, which guarantees a whole OFDM symbol is used instead of the quarter OFDM symbol.

Equation (10) needs to be changed to Equation (6) to guarantee the whole OFDM symbol is added as the extra OFDM symbol.

$${N}_{SYM} = {N}_{SYM , init} + 1 , a = 4. \qquad Equation ( 6 )$$

These proposals simplify the LDPC rate matching procedure for 20 MHz-only devices.

7. In some other embodiments, a new PPDU format for extended range (ER) is defined. The preamble design for the ER PPDU includes the following properties:
The 2^{nd} OFDM symbol after the RL-SIG shall be Q-PSK modulated to enable the legacy device to detect the PPDU as the ER PPDU;
The L-SIG and the U-SIG field shall be repeated several times in the time domain to achieve a longer range.

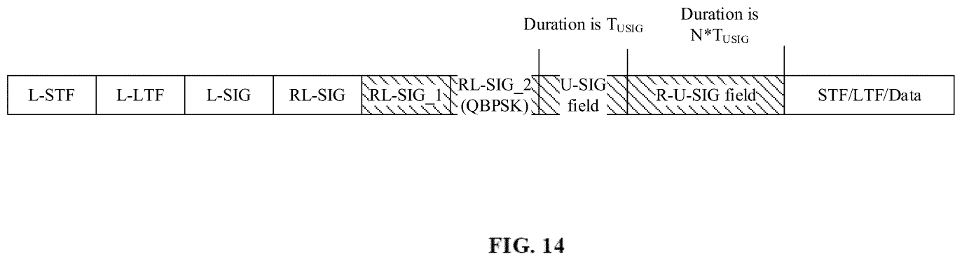

In some embodiments, as illustrated in FIG. 14, the L-SIG is repeated 4 times (L-SIG, RL-SIG, RL-SIG_1, RL-SIG_2), and U-SIG field is also repeated by the R-U-SIG field. The number of repetitions in R-U-SIG is predefined, in some instances.

As illustrated in FIG. 14, the following fields are included: a legacy short training field (L-STF), a legacy long training field (L-LTF), a L-SIG, a RL-SIG, RL-SIG_1, RL-SIG_2, a U-SIG, and a R-U-SIG, and a short training field (STF) or a long training field (LTF)/data.

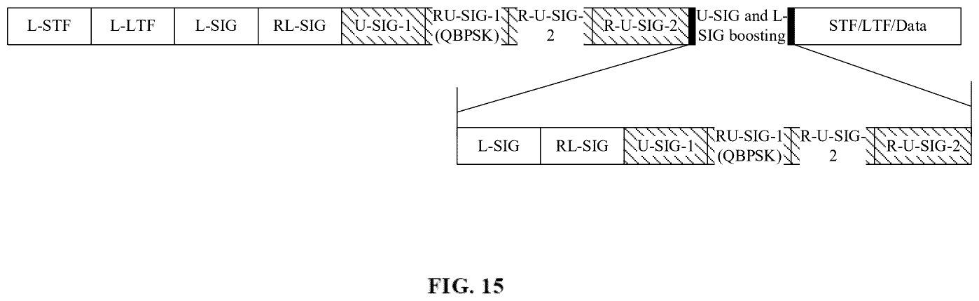

In some embodiments, as illustrated in FIG. 15, the 2^{nd} symbol after the RL-SIG is still QBPSK, while the structure of U-SIG-1, R-U-SIG-1, U-SIG-2, and R-U-SIG2 maintains. The legacy device can decode the U-SIG field and pass the version independent information to the MAC.

A new field is added named as “U-SIG and L-SIG boosting”, in order to boost the performance for the STA that can recognize this new PPDU format (e.g., WiFi 8 STA and beyond). The “U-SIG and L-SIG boosting” field includes the time domain repeated version of the L-SIG and U-SIG to achieve combination gain and boost performance for decoding or PPDU format detection. In some embodiments, the previous L-SIG and U-SIG field as illustrated in FIG. 15 is repeated.

When there are other SIG fields (e.g., UHR-SIG), the SIG boost field will also include those fields.

In the method for wireless communication provided in the Embodiment 3:
a 20 MHz-only device disables support of the 26-tone RU or the support of both the 26-tone RU and the 52-tone RU; and
the 20 MHz-only device assigns 1 to 3 bits to indicate a RU location.

The solutions in Embodiment 1 to Embodiment 3 above may be implemented individually or in combination of two or three of them.

Preferred embodiments of the present disclosure have been described in detail with reference to the accompanying drawings, but the present disclosure is not limited to the specific details of the above embodiments. Within the scope of the technical conception of the present disclosure, various simple modifications may be made to the technical scheme of the present disclosure, and these simple modifications all fall within the scope of protection of the present disclosure. For example, specific technical features described in the above specific embodiments may be combined in any suitable manner without contradiction, and various possible combinations are not further described in this disclosure in order to avoid unnecessary repetition. For another example, various different implementations of the present disclosure may be combined arbitrarily as long as the combination does not depart from the idea of the present disclosure, and the combination should be regarded as the contents of the present disclosure. For another example, various embodiments and/or the technical features of the various embodiments in the present disclosure may be combined with the related art in any manner without conflict, and the resulting technical solutions shall also fall within the scope of protection of the present disclosure.

It is to be understood that, in various method embodiments of the present disclosure, a magnitude of a sequence number of each process does not mean an execution sequence and the execution sequence of each process should be determined by its function and an internal logic and should not form any limit to an implementation process of the embodiments of the present disclosure. Furthermore, in the embodiments of the present disclosure, the terms “downlink”, “uplink” and “sidelink” are used to indicate a direction of transmission of signals or data, “downlink” is used to indicate that the signal or data is transmitted in a first direction from a station to user equipment (UE) of a cell, “uplink” is used to indicate that the signal or data is transmitted in a second direction from UE of a cell to a station, and “sidelink” is used to indicate that the signal or data is transmitted in a third direction from UE 1 to UE 2. For example, “downlink signal” indicates that the signal is transmitted in the first direction. Further, in the embodiments of the present disclosure, the term “and/or” is only an association relationship describing associated objects and represents that three relationships may exist. Specifically, A and/or B may represent three conditions: i.e., independent existence of A, existence of both A and B, and independent existence of B. In addition, the character “/” in the present disclosure usually represents that previous and next associated objects form an “or” relationship.

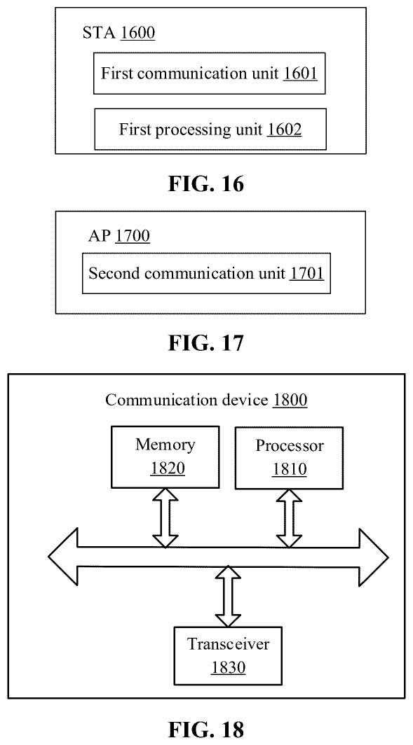

FIG. 16 is a schematic diagram illustrating a structural composition of a STA according to an embodiment of the present disclosure. As illustrated in FIG. 16, the STA 1600 includes a first communication unit 1601 and a first processing unit 1602.

The first communication unit 1601 is configured to receive a non-TB sounding frame from an AP.

The first processing unit 1602 is configured to adjust a CBF based on a first matrix. The CBF is configured to respond to the non-TB sounding frame, and the first matrix is used for controlling a ratio between SNRs of two spatial streams of the CBF.

The first communication unit 1601 is further configured to transmit the adjusted CBF to the AP.

In some embodiments, the first matrix is determined is determined based on a first parameter, and the first parameter is predefined or determined by the STA.

In some embodiments, the first communication unit 1601 is further configured to: transmit, if a first parameter is determined by the STA, the first parameter to the AP. The first parameter is used by the AP for determining a beamforming matrix.

In some embodiments, the first communication unit 1601 is further configured to receive beamformed data from the AP. The number of spatial streams of the beamformed data is a first number.

In some embodiments, the first number is determined a second parameter indicated by the AP to the STA.

In some embodiments, the second parameter is carried in a NDPA frame sent by the AP to the STA.

In some embodiments, the first number is indicated by a CBF transmitted from the STA to the AP.

In some embodiments, spatial stream data of the CBF is the first number.

In some embodiments, the first number is a number of spatial streams used for a preferred feedback selected from multiple CBF candidates, and different CBF candidates have different numbers of spatial streams.

In some embodiments, the CBF candidates having different numbers of spatial streams are carried in one or multiple action frames.

In some embodiments, an action frame carrying a CBF candidate further carries a number of spatial streams of the CBF candidate.

In some embodiments, the first processing unit 1602 is further configured to indicate a highest MCS in a HT control field, and the first communication unit 1601 is further configured to transmit a first message to the AP. The first message includes the HT control field.

In some embodiments, the highest MCS is indicated by a first field in a HE variant of an A-control field in the HT control field.

In some embodiments, the first field is an EHT OM control subfield or a defined control information subfield.

In some embodiments, the highest MCS is indicated by a reserved field in the EHT OM control subfield.

In some embodiments, a control identifier with a reserved value in the A-control field indicates adding the defined control information subfield in the HE variant.

In some embodiments, a device category of the STA is a first category or a second category. A device of the first category only supports a bandwidth of 20 MHz, and a device of the second category supports a bandwidth greater than or equal to 80 MHz.

In some embodiments, the device of the first category disables support of a first RU or support of both the first RU and a second RU. The first RU is a RU including 26 subcarriers, and the second RU is a RU including 52 subcarriers.

In some embodiments, a RU allowed by the device of the first category is indicated by a second number of bits. The second number is less than or equal to 3.

In some embodiments, the device of the first category is disallowed to participate a wider bandwidth OFDMA PPDU reception, and/or the device of the first category optionally participates the wider bandwidth OFDMA PPDU reception.

In some embodiments, the device of the first category uses 16 microseconds extension.

In some embodiments, an integer number of OFDM symbols is padded for the device of the first category in FEC padding.

In some embodiments, a LDPC extra symbol is one whole extra OFDM symbol for the device of the first category.

In some embodiments, the first communication unit 1601 is further configured to receive a first PPDU for an ER from the AP if the device category of the STA is the first category.

In some embodiments, in a preamble of the first PPDU, a second OFDM symbol after a RL-SIG is quadrature phase shift keying modulated; and/or an L-SIG and a U-SIG are repeated in the time domain.

In some embodiments, the preamble of the first PPDU comprises a defined second field for indicating that a PPDU in which the defined second field is located is the first PPDU.

In some embodiments, the second field comprises a time domain repeated version of the L-SIG and the U-SIG.

The first communication unit in the STA may be implemented by a transceiver in the STA. The first processing unit in the STA may be implemented by a processor in the STA.

FIG. 17 is a schematic diagram illustrating a structural composition of an AP according to an embodiment of the present disclosure. As illustrated in FIG. 17, the AP 1700 includes a second communication unit 1701.

The second communication unit 1701 is configured to transmit a non-TB sounding frame to a STA.

The second communication unit 1701 is further configured to receive a CBF adjusted based on a first matrix from the STA. The CBF is configured to respond to the non-TB sounding frame, and the first matrix is used for controlling a ratio between SNRs of two spatial streams of the CBF.

In some embodiments, the first matrix is determined is determined based on a first parameter, and the first parameter is predefined or determined by the STA.

In some embodiments, the second communication unit 1701 is further configured to receive a first parameter from the STA if the first parameter is determined by the STA. The first parameter is used by the AP for determining a beamforming matrix.

In some embodiments, the second communication unit 1701 is further configured to transmit beamformed data to the STA. A number of spatial streams of the beamformed data is a first number.

In some embodiments, the first number is determined a second parameter indicated by the AP to the STA.

In some embodiments, the second parameter is carried in a NDPA frame sent by the AP to the STA.

In some embodiments, the first number is indicated by a CBF transmitted from the STA to the AP.

In some embodiments, spatial stream data of the CBF is the first number.

In some embodiments, the first number is a number of spatial streams used for a preferred feedback selected from multiple CBF candidates, and different CBF candidates have different numbers of spatial streams.

In some embodiments, the CBF candidates having different numbers of spatial streams are carried in one or multiple action frames.

In some embodiments, an action frame carrying a CBF candidate further carries a number of spatial streams of the CBF candidate.

In some embodiments, the second communication unit 1701 is further configured to receive a first message from the STA. The first message includes a HT control field indicating a highest MCS.

In some embodiments, the highest MCS is indicated by a first field in a HE variant of an A-control field in the HT control field.

In some embodiments, the first field is an EHT OM control subfield or a defined control information subfield.

In some embodiments, the highest MCS is indicated by a reserved field in the EHT OM control subfield.

In some embodiments, a control identifier with a reserved value in the A-control field indicates adding the defined control information subfield in the HE variant.

In some embodiments, a device category of the STA is a first category or a second category. A device of the first category only supports a bandwidth of 20 MHz, and a device of the second category supports a bandwidth greater than or equal to 80 MHz.

In some embodiments, the device of the first category disables support of a first RU or support of both the first RU and a second RU. The first RU is a RU including 26 subcarriers, and the second RU is a RU including 52 subcarriers.

In some embodiments, a RU allowed by the device of the first category is indicated by a second number of bits. The second number is less than or equal to 3.

In some embodiments, the device of the first category is disallowed to participate a wider bandwidth OFDMA PPDU reception, and/or the device of the first category optionally participates the wider bandwidth OFDMA PPDU reception.

In some embodiments, the device of the first category uses 16 microseconds extension.

In some embodiments, an integer number of OFDM symbols is padded for the device of the first category in FEC padding.

In some embodiments, a LDPC extra symbol is one whole extra OFDM symbol for the device of the first category.

In some embodiments, the second communication unit 1701 is also configured to transmit a first PPDU for an ER to the STA if the device category of the STA is the first category.

In some embodiments, in a preamble of the first PPDU, a second OFDM symbol after a RL-SIG is quadrature phase shift keying modulated; and/or an L-SIG and a U-SIG are repeated in the time domain.

In some embodiments, the preamble of the first PPDU includes a defined second field for indicating that a PPDU in which the defined second field is located is the first PPDU.

In some embodiments, the second field includes a time domain repeated version of the L-SIG and the U-SIG.

It should be noted that the AP may further include a second processing unit for performing processing such as generation of the first PPDU.

The second communication unit in the AP may be implemented by a transceiver in the AP. The second processing unit in the AP may be implemented by a processor in the AP.

It should be understood by those skilled in the art that the descriptions about the STA and the AP in the embodiments of the present disclosure may be understood with reference to the descriptions about the methods for wireless communication in the embodiments of the present disclosure.

FIG. 18 is a schematic structural diagram of a communication device 1800 according to an embodiment of the present disclosure. The communication device may be a STA or an AP. The communication device 1800 illustrated in FIG. 18 includes a processor 1810. The processor 1810 is configured to call a computer program from a memory and run the computer program to implement the methods in the embodiments of the present disclosure.

In an embodiment, as illustrated in FIG. 18, the communication device 1800 may further include a memory 1820. The processor 1810 may call the computer program from the memory 1820 and run the computer program to implement the methods in the embodiments of the present disclosure.

The memory 1820 may be a separate device independent of the processor 1810 or may be integrated into the processor 1810.

In an embodiment, as illustrated in FIG. 18, the communication device 1800 may further include a transceiver 1830. The processor 1810 may control the transceiver 1830 to communicate with other devices, in particular, to send information or data to other devices, or receive information or data sent by other devices.

The transceiver 1830 may include a transmitter and a receiver. The transceiver 180 may further include an antenna. The number of the antennas may be one or more.

In an embodiment, the communication device 1800 may specifically be an AP in the embodiments of the present disclosure, and the communication device 1800 may implement corresponding processes implemented by the AP in each method of the embodiments of the present disclosure. For simplicity, elaborations are omitted herein.

In an embodiment, the communication device 1800 may specifically be a mobile terminal/STA in the embodiments of the present disclosure, and the communication device 1800 may implement corresponding processes implemented by the mobile terminal/STA in each method of the embodiments of the present disclosure. For simplicity, elaborations are omitted herein.

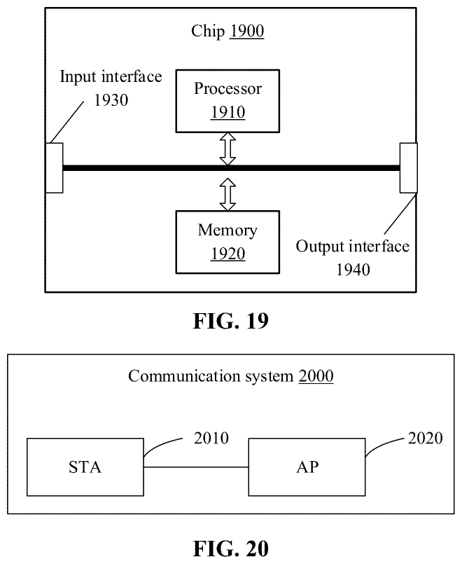

FIG. 19 is a schematic structural diagram of a chip according to an embodiment of the present disclosure. The chip 1900 illustrated in FIG. 19 includes a processor 1910, and the processor 1910 is configured to call a computer program from a memory and run the computer program to implement the methods in the embodiments of the present disclosure.

In an embodiment, as illustrated in FIG. 19, the chip 1900 may further include a memory 1920. The processor 1910 is configured to call the computer program from the memory 1920 and run the computer program to implement the methods in the embodiments of the present disclosure.

The memory 1920 may be a separate device independent of the processor 1910 or may be integrated into the processor 1910.

In an embodiment, the chip 1900 may further include an input interface 1930. The processor 1910 may control the input interface 1930 to communicate with other devices or chips, and in particular may acquire information or data from the other devices or chips.

In an embodiment, the chip 1900 may further include an output interface 1940. The processor 1910 may control the output interface 1940 to communicate with other devices or chips, and in particular may output information or data to the other devices or chips.

In an embodiment, the chip may be applied to the AP in the embodiments of the present disclosure, and the chip may implement corresponding processes implemented by the AP in each method of the embodiments of the present disclosure. For simplicity, elaborations are omitted herein.

In an embodiment, the chip may be applied to the mobile terminal/STA in the embodiments of the present disclosure, and the chip may implement corresponding processes implemented by the mobile terminal/STA in each method of the embodiments of the present disclosure. For simplicity, elaborations are omitted herein.

It is to be understood that the chip mentioned in the embodiments of the present disclosure may also be called a system-level chip, a system chip, a chip system or a system on chip, or the like.

FIG. 20 is a schematic block diagram of a communication system 2000 according to an embodiment of the present disclosure. As illustrated in FIG. 20, the communication system 2000 includes a STA 2010 and an AP 2020.

The STA 2010 may be configured to implement the corresponding functions implemented by the STA in the above methods, and the AP 2020 may be configured to implement the corresponding functions implemented by the AP in the above methods. For simplicity, elaborations are omitted herein.

It should be understood that the processor in the embodiments of the present disclosure may be an integrated circuit chip with a signal processing capability. During implementation, each operation of the above method embodiments may be completed by an integrated logic circuit of hardware in the processor or an instruction in form of software. The processor may be a general-purpose processor, a Digital Signal Processor (DSP), an Application Specific Integrated Circuit (ASIC), a Field Programmable Gate Array (FPGA), or another programmable logical device, discrete gate or transistor logical device and discrete hardware component. Each method, operation and logical block diagram disclosed in the embodiments of the present disclosure may be implemented or executed. The general-purpose processor may be a microprocessor or the processor may also be any conventional processor and the like. The operations of the method disclosed in combination with the embodiments of the present disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-Only Memory (ROM), a Programmable ROM (PROM) or an electrically erasable programmable memory, and a register. The storage medium is located in a memory, and the processor reads information in the memory, and completes operations of the above methods in combination with hardware thereof.

It is to be understood that the memory in the embodiments of the present disclosure may be a volatile memory or a non-volatile memory, or may include both volatile and non-volatile memories. The non-volatile memory may be a ROM, a PROM, an Erasable PROM (EPROM), an Electrically EPROM (EEPROM), or a flash memory. The volatile memory may be a Random Access Memory (RAM) used as an external cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It is to be noted that the memory of the system and method described in the present disclosure is intended to include, but not limited to, memories of these and any other proper types.

It is to be understood that the above memory is exemplarily but unlimitedly described. For example, the memory in the embodiments of the present disclosure may also be an SRAM, a DRAM, an SDRAM, a DDR SDRAM, an ESDRAM, an SLDRAM and a DR RAM. That is, the memory in the embodiments of the present disclosure is intended to include but not limited to memories of these and any other proper types.

An embodiment of the present disclosure further provides a computer-readable storage medium configured to store a computer program.

In an embodiment, the computer-readable storage medium may be applied to the AP in the embodiments of the present disclosure, and the computer program causes a computer to execute corresponding processes implemented by the AP in each method of the embodiments of the present disclosure. For simplicity, elaborations are omitted herein.

In an embodiment, the computer-readable storage medium may be applied to the mobile terminal/STA in the embodiments of the present disclosure, and the computer program causes a computer to execute corresponding processes implemented by to the mobile terminal/STA in each method of the embodiments of the present disclosure. For simplicity, elaborations are omitted herein.

An embodiment of the present disclosure further provides a computer program product including computer program instructions.

In an embodiment, the computer program product may be applied to the AP in the embodiments of the present disclosure, and the computer program instructions cause a computer to execute corresponding processes implemented by the AP in each method of the embodiments of the present disclosure. For simplicity, elaborations are omitted herein.

In an embodiment, the computer program product may be applied to the mobile terminal/STA in the embodiments of the present disclosure, and the computer program instructions cause a computer to execute corresponding processes implemented by the mobile terminal/STA in each method of the embodiments of the present disclosure. For simplicity, elaborations are omitted herein.

An embodiment of the present disclosure further provides a computer program.

In an embodiment, the computer program may be applied to the AP in the embodiments of the present disclosure. The computer program, when run on a computer, enables the computer to execute corresponding processes implemented by the AP in each method of the embodiments of the present disclosure. For simplicity, elaborations are omitted herein.

In an embodiment, the computer program may be applied to the mobile terminal/STA in the embodiments of the present disclosure. The computer program, when run on a computer, enables the computer to execute corresponding processes implemented by the mobile terminal/STA in each method of the embodiments of the present disclosure. For simplicity, elaborations are omitted herein.

Those of ordinary skill in the art may realize that the units and algorithm operations of each example described in combination with the embodiments disclosed in the present disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the present disclosure.

Those skilled in the art may clearly learn about that specific working processes of the system, apparatus and unit described above may refer to the corresponding processes in the method embodiments and will not be elaborated herein for convenient and brief description.

In some embodiments provided by the present disclosure, it is to be understood that the disclosed system, apparatus and method may be implemented in another manner. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the present disclosure may be integrated into a processing unit, each unit may also physically exist independently, and two or more than two units may also be integrated into a unit.

When being realized in form of software functional unit and sold or used as an independent product, the function may also be stored in a computer-readable storage medium. Based on such an understanding, the technical solutions of the present disclosure substantially or parts making contributions to the conventional art or part of the technical solutions may be embodied in form of software product, and the computer software product is stored in a storage medium, including multiple instructions configured to enable a computer device (which may be a personal computer, a server, an access point or the like) to execute all or part of the operations of the method in each embodiment of the present disclosure. The abovementioned storage medium includes: various media capable of storing program codes such as a U disk, a mobile hard disk, a ROM, a RAM, a magnetic disk or an optical disk.

The above is only the specific implementation of the present disclosure and not intended to limit the scope of protection of the present disclosure. Any variations or replacements apparent to those skilled in the art within the technical scope disclosed by the present disclosure shall fall within the scope of protection of the present disclosure. Therefore, the scope of protection of the present disclosure shall be subject to the scope of protection of the claims.

1. A method for wireless communication, comprising:
transmitting, by a station (STA), a first message to an access point (AP), the first message carrying a field indicating a highest modulation and coding scheme (MCS).

2. The method of claim 1, wherein the first message is used for the STA to change supported maximum MCS.

3. The method of claim 1, further comprising:
receiving, by the STA from the AP, a first physical layer protocol data unit (PPDU) for an extended range,
wherein the STA is a 20 MHz-only device.

4. The method of claim 3, wherein a preamble of the first PPDU comprises a second field for indicating that a PPDU in which the second field is located is the first PPDU.

5. The method of claim 1, wherein different MCSs are used by the STA for different streams when performing PPDU transmission.

6. The method of claim 1, wherein the field is a high throughput (HT) control field, and the highest MCS is indicated by a first field in a high efficiency (HE) variant of an A-control field in the HT control field.

7. The method of claim 6, wherein the first field is an extremely high throughput (EHT) operating mode (OM) control subfield or a defined control information subfield.

8. The method of claim 7, wherein the highest MCS is indicated by a reserved field in the EHT OM control subfield.

9. An access point (AP), comprising: a processor and a memory, wherein the memory is configured to store a computer program, and the processor is configured to call and run the computer program to cause the AP to:
receive a first message from a station (STA), the first message carrying a field indicating a highest modulation and coding scheme (MCS).

10. The AP of claim 9, wherein the processor is configured to call and run the computer program to cause the AP to transmit a first physical layer protocol data unit (PPDU) for an extended range to the STA,
wherein the STA is a 20 MHz-only device.

11. The AP of claim 10, wherein a preamble of the first PPDU comprises a second field for indicating that a PPDU in which the second field is located is the first PPDU.

12. The AP of claim 9, wherein different MCSs are used by the AP for different streams when performing PPDU transmission.

13. The AP of claim 9, wherein the field is a high throughput (HT) control field, and the highest MCS is indicated by a first field in a high efficiency (HE) variant of an A-control field in the HT control field.

14. The AP of claim 11, wherein the first field is an extremely high throughput (EHT) operating mode (OM) control subfield or a defined control information subfield.

15. The AP of claim 14, wherein the highest MCS is indicated by a reserved field in the EHT OM control subfield.

16. A station (STA), comprising: a processor and a memory, wherein the memory is configured to store a computer program, and the processor is configured to call and run the computer program to cause the STA to:
transmit a first message to an access point (AP), the first message carrying a field indicating a highest modulation and coding scheme (MCS).

17. The STA of claim 16, wherein the first message is used for the STA to change supported maximum MCS.

18. The STA of claim 16, wherein the processor is configured to call and run the computer program to cause the STA to receive a first physical layer protocol data unit (PPDU) for an extended range from the AP,
wherein the STA is a 20 MHz-only device.

19. The STA of claim 18, wherein a preamble of the first PPDU comprises a second field for indicating that a PPDU in which the second field is located is the first PPDU.

20. The STA of claim 16, wherein different MCSs are used by the STA for different streams when performing PPDU transmission.
